(19) United States
(12) Patent Application Publication
(10) Pub. No.: US 2004/0166470 A1
(43) Pub. Date: Aug. 26, 2004

(54) Occlusal marking system and method of use

(76) Inventor: N. David Crow, Cocolalla, ID (US)

Correspondence Address: Christopher A. Wiklof, 3531 99th St. SE, Everett, WA, 98208, US

(21) Appl. No.: 10/785,661

(22) Filed: Feb. 23, 2004

Related U.S. Application Data
(60) Provisional application No. 60/450,138, filed on Feb. 25, 2003.

(51) Int. Cl. A61C 9/00

(52) U.S. Cl. 433/70

(57) ABSTRACT

A dental marking film holder holds articulating film in a patient's mouth, reducing the number of hands needed for the procedure. A pair of safety glasses worn by the patient includes a mounting point for affixing a mount to. In some embodiments, the mount is a clamp that attaches to the bridge of the glasses. In other embodiments, a mounting point on the glasses forms a ball-and-socket joint with the mount. The mount is connected to an articulating film holder by a flexible coupling. The flexible coupling provides for adapting to the geometry of an individual's face and for stably holding the articulating film holder at a range of positions. The articulating film holder accepts forceps that hold articulating film. In some embodiments, the articulating film includes disposable forceps. The articulating film holder adapts to a range of dental arch widths.

### CROSS REFERENCE TO RELATED APPLICATIONS

The present application depends and claims priority from the Provisional Patent Application entitled DENTAL BITE MEASUREMENT FILM AND APPARATUS, serial No. 60/450,138, filed Feb. 25, 2003, invented by Dr. N. David Crow.

### FIELD OF THE INVENTION

The present invention relates to a dental material and apparatus for bite determination, and more specifically to an apparatus for performing dental articulation.

### BACKGROUND

Dentists, orthodontists, and other professionals use dental marking films, or articulating films, to determine the bite characteristics of patients. By placing a piece of articulating film between the patient's teeth and moving the jaw through a range of movement, the film leaves an imprint on those areas of the teeth that come into contact with one another. Using such a technique, dentists are able to visualize the contact areas of the teeth and adjust the bite as may be desired.

When skill and care are used to prevent wrinkling of the articulation film, it may also be possible to visualize contact by inspection of the film itself.

It is frequently desirable for the dental professional to guide the patient's jaw through a range of motion. In such cases, the process of articulation may require additional personnel to assist in holding the articulating film in place.

In other instances, it may be desirable to present the articulating film in a more precise or repeatable manner than is convenient or possible by hand.

In other instances, articulation may be used in the preparation of dentures, braces, or other dental devices. It may be desirable to tune the bite of such apparatus prior to placement in the patient's mouth. In such cases, presenting the articulating film by hand may be impractical or undesirable.

### OVERVIEW

According to various embodiments and aspects of the present invention, an apparatus and method to aid in dental articulation, creation of prostheses, and other applications related to the determination of a patient's bite is taught.

In one aspect according to the present invention, a dental bite determination apparatus reduces the effort on the part of the practitioner for the procedure. Such bite determination may be performed in a “hands-free” manner where the practitioner may rely on the apparatus to present and hold the articulating film, thus allowing the practitioner to perform other aspects of the procedure such as, for example, manually moving the patient's jaw through a range of motion with one hand while stabilizing the back of the patient's head with the other hand. The apparatus may further reduce the cost of labor by reducing or eliminating the need for an assistant to position and hold the articulating film while the practitioner performs other functions.

In another aspect, patient comfort may be improved by gently guiding articulating film into the patient's mouth using the patient's cheeks as guide-ways. An articulating film is held by a smooth, non-metallic forceps that is adapted to being gently pressed against the patient's cheeks with minimal discomfort. A rounded tip on the forceps spreads the compressive load against the patient's cheeks, gums, and teeth to reduce the incidence of pain.

In another aspect, a dental marking film includes features for easily and securely fitting it to a spreader. The spreader includes corresponding features for securely gripping the dental marking film.

In another aspect, a dental bite determination apparatus and associated dental marking film have features for mounting the film in a plurality of orientations. In one orientation, one or two pieces of articulating film is presented longitudinally to measure the bite characteristics of the back teeth. In another orientation, the articulating film is presented laterally to measure the bite of the front teeth. Other embodiments allow various combinations of front and back teeth to be measured with single or plural articulating elements. Articulating elements may include conventional marking films of various types as well as sensing elements such as analog and digital sensors.

In still another aspect, a dental marking film includes an integral handle or forceps amenable either to insertion into a hands-free apparatus or being hand-held. The inclusion of an integral forceps with the dental marking film further makes it cleaner and easier to use.

In another aspect, a dental bite determination apparatus includes features for easy and reliable insertion into a patient's mouth. A forceps attached to the edge of a marking film itself, is laterally pressed against the inside of a patient's cheek by the spreader, thus holding a marking film in a proper orientation between the upper and lower teeth. As the forceps is slid posteriorly, it is gently guided by the cheek. The proper insertion depth is determined by pressure of the end of the forceps against the patient's jaw. The forceps holder may provide spring action to gently hold the forceps in an appropriate orientation and with appropriate pressure. Alternatively, a friction clamp provides appropriate resistance to medial movement to ensure the forceps are gently engaged laterally against the patient's cheeks.

In another aspect, a dental bite determination apparatus includes a spreader that holds the width of a pair of forceps holding articulating film by use of a friction fitting. The friction fitting allows insertion of the articulating film in a closed position, wherein both forceps are held near the center of the patient's mouth. The practitioner may then spread the forceps to an appropriate width that positions the articulating film over the patient's dental arches using finger pressure. In some embodiments, a frictional holding power of approximately 3 inch-ounces has been found to provide satisfactory performance.

In another aspect, a digital bite pressure apparatus includes a spreader having a variable width accommodation. One or a pair of forceps holding articulating film are coupled to the spreader. The spreader may include a fork fitting that releasably couples to the distal end of a holder rod. The fork allows the spreader to rotate in both a horizontal and a vertical plane and slide up and down the connector rod to adapt to the size and shape of patients' heads and mouths. The holder rod includes a socket joint on its proximal end, the socket joint being adapted to reversibly couple to a corresponding ball joint mounted on the end of a nose post. The nose post is affixed or formed integrally to the bridge of a pair of safety glasses. The patient is fitted with the safety glasses having the nose post thereon. The socket joint is connected to the ball joint on the end of the nose post, thus forming a universal joint that allows the connector rod to rotate. The freedom or ease of rotation may be adjusted by tightening or loosening the threaded end of the connector rod in the socket joint, thus pressing more tightly or more loosely, respectively, against the ball joint. The universal joint and fork joint are then adjusted to admit the distal end of the forceps and articulating film into the patient's mouth. The width of the spreaders may be easily adjusted to accommodate the width of a variety of dental arches. Once placed, the assembly is held securely enough to allow the practitioner to let go of the forceps and/or spreader and use both hands to perform other aspects of articulation.

In another aspect, patient safety glasses provide a secure and convenient mounting point for a variety of dental and medical apparatus. In particular applications, a mechanical mounting point or coupling may be mounted on or formed integrally to the glasses. A corresponding mount may be removably attached thereto, the corresponding mount, in turn, being coupled to a mechanical coupling or holder arm that attaches to a spreader. The mechanical coupling or holder arm allows for convenient positioning of the spreader and retains its position and angle once set, until the practitioner repositions the spreader. The spreader includes provision for accepting articulating film forceps, which in turn hold the articulating film itself. The spreader includes provision for adjusting the angle of the forceps to match the width of the dental arches of the patient.

In various embodiments, the adjustable holder arm may be formed proximally or distally to the mounting point and separable mount, relative to the patient. In some embodiments an adjustable holder arm may be integrated with the mounting point, thus making the position of the mounting point itself adjustable. Thus, the adjustable arm is attached, for example, to a pair of safety glasses and has a mounting point on its distal end for accepting the spreader.

In other embodiments according to the invention, the mounting point may be established in a particular position in space, with the adjustable holder arm being placed distally relative to the mounting point. Thus, the mounting point is attached, for example, to a pair of safety glasses, the mounting point accepting the proximal end of the adjustable arm.

In another aspect according to the invention, an adjustable dental marking film holder is amenable to testing of molds of a patient's teeth, dentures or other appliances outside the patient's mouth. A fitting holds the appliance and/or mold of the patient's teeth in an appropriate orientation, a mount allows for coupling a post, which in turn accepts a spreader for positioning a marking film in the bite region of the appliance to be tested. Articulation may be performed in a manner similar to that of live articulation on the patient.

### BRIEF DESCRIPTION OF THE DRAWINGS

FIG. 1 is an isometric view of a marking film holder apparatus having a compound holder arm and an operative position on safety glasses worn by a dental patient.

FIG. 2 is an enlarged isometric view of the marking film holder of FIG. 1, showing an embodiment where an articulating joint is located in the holder arm.

FIG. 3 is an enlarged partial side-sectional view through the interconnection of the glasses fastening body and the holder arm, taken on the line 3-3 on FIG. 2.

FIG. 4 is an enlarged cross-sectional view through the glasses fastening body of the holder, taken on line 4-4 on FIG. 2.

FIG. 5 is an enlarged cross-sectional view through the joint interconnecting the upper and lower portions of the holder arm, taken on the plane 5-5 on FIG. 2.

The FIG. 6 is a side-sectional view through the interconnection of the holder arm and the spreader, taken on the plane 6-6 on FIG. 2.

FIG. 7 is an enlarged partial rear orthographic view of the spreader with forceps accepting slots in the closed (medial) position.

FIG. 8 is an isometric view of protective eyeglasses usable support the marking film holder.

FIG. 9 is an isometric view of a marking film and forceps assembly.

FIG. 10 is a side-sectional view through the forceps and marking film assembly of FIG. 9, taken on the line 10^{-10.}

FIG. 11 is a cross-sectional view through the marking film and forceps assembly of FIG. 9, taken on the line 11-11.

FIG. 12 is an isometric view of a marking film holder having a universal joint and L-shaped holder arm.

FIG. 13 is an enlarged isometric view of the marking film holder of FIG. 12.

FIG. 14 is a partial enlarged side-sectional view through the universal joint (also referred to as the mount and mounting point, and alternatively as the fastening body) of the marking film holder of FIG. 13, taken on the line 14-14.

FIG. 15 is an isometric view of an alternative holder arm that is plastically formable.

FIG. 16 is a partial side-sectional view through the fastening body of the marking film holder of FIG. 15, taken on a line 16-16.

FIG. 17 is a cross-sectional view of the marking film holder arm shown in FIGS. 18-20, taken through the ball-and-socket joint formed between the mount 20c and mounting point 74, the mounting point being formed on the bridge of a pair of safety glasses.

FIG. 18 is a perspective view of a dental marking film holder being inserted into the mouth of a patient. FIG. 18 further illustrates an embodiment of the nose post and holder arm that are coupled through a universal joint.

FIG. 19 is a perspective view of an apparatus for hands-free support of a dental marking film as worn by a patient. FIG. 19 illustrates a first marking film position for measuring the bite of a patient's rear teeth. It further illustrates the ability of the practitioner to operate the apparatus in a “hands-free” manner, instead using both hands to move the patient's jaw through a range of motion.

FIG. 20 is a perspective view of a dental marking film holder as worn by a patient illustrating an alternative marking film orientation for measuring the bite of the front teeth, and particularly for harmonizing the anterior guidance.

FIG. 21 is an isometric view of a dental marking film having integral forceps with registration features.

FIG. 22 is a side-sectional view of a dental marking film having integral forceps with registration features.

FIG. 23 is a side-sectional view of a spreader clamped onto the forceps of FIGS. 21 and 22.

FIG. 24 is an isometric view of a dental marking film having forceps with alternative registration features.

FIG. 25 is an isometric view of a dental marking film having forceps with other alternative registration features.

FIG. 26 is a plan view of an adaptor for inserting alternative marking film forceps into a spreader.

FIG. 27A is a top view of an alternative dental marking film forceps.

FIG. 27B is a side view of the alternative dental marking film forceps of FIG. 27A.

FIG. 27C is a detail top view of the alternative dental marking film forceps of FIGS. 27A and 27B showing the latch mechanism.

### DETAILED DESCRIPTION OF THE INVENTION

The marking film holder of FIG. 1 generally provides nose post 20 mounted to safety glasses 19 and carrying holder arm 21. Spreader 22 is coupled to holder arm 21. Marking film and forceps assemblies 23 are mounted in the spreader and are positioned in a laterally spread configuration. Nose post 20 is alternatively called a glasses fastening body. Holder arm 21 is alternatively called a holder rod or coupling or adjustable arm.

Safety glasses 19, also illustrated by FIG. 8, are one type of head mounting apparatus that may be used to support the marking film holder. The safety glasses 19 may be a commercially available type used for eye protection for dental patients. The safety glasses have laterally opposed, rearwardly extending ear bows 24 for support on the patient's ears. The ear bows 24 are interconnected at their forward ends by face bow 25 having medial nose bridge 26 and carrying a protective lens 27 on each side of the nose bridge 26. One attribute for such safety glasses is that they provide a nose bridge 26 that allows attachment of the nose post 20. Thus, the glasses form a structure that allows for mounting the occlusal marking system in a location that is substantially constant relative to the patient's mouth.

As an alternative to fastening the occlusal marking system to the nose bridge of a pair of safety glasses, other mounting points may be used according to the preference of the designer and practitioner. For example, a Y-shaped support may extend forward from the corners of the face bow where it joins the ear bows. Alternatively, a hat, helmet, or other secure head mount may be used.

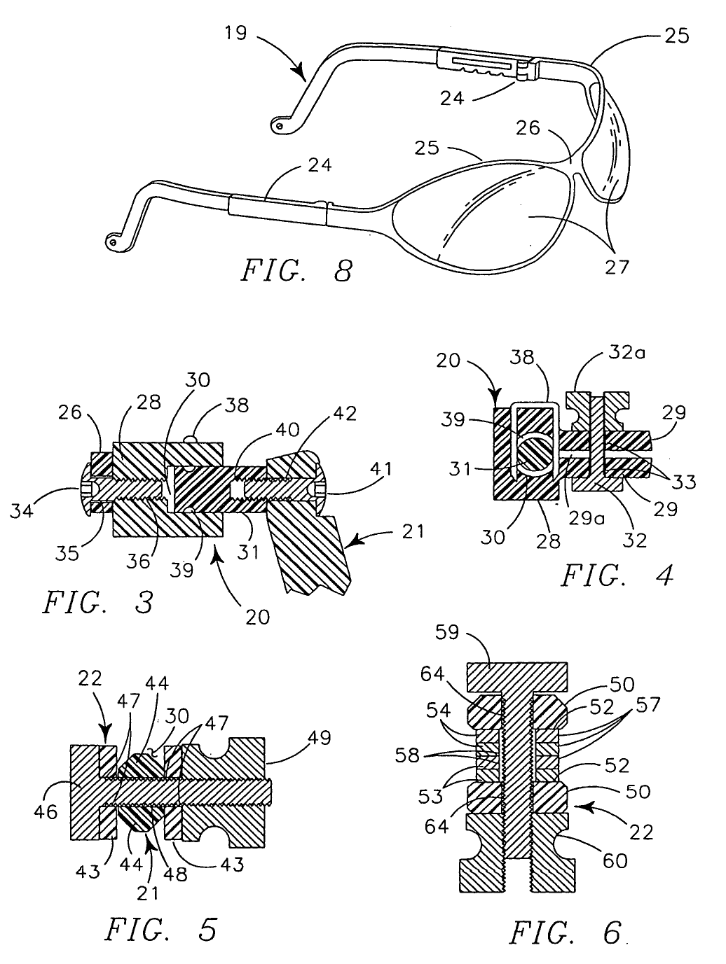

The nose post, or glasses fastening body, 20 as seen in FIGS. 1-7, and in section in FIGS. 3 and 4, includes a clamp comprising body 28 and legs 29 that together form the clamp structure. Cavity 30 extends into the clamp to accept holder arm fastening pin 31. Bolt 32 extends through holes 33 perpendicular to legs 29 to engage knurled nut 32a. Tightening or loosening the knurled nut 32a moves legs 29 relative to one other and regulates the amount of frictional contact between the holder arm fastening pin 31 and cavity 30.

Bolt 34 passes through hole 35 defined in the nose bridge 26 of the safety glasses 19 to engage threaded hole 36 defined in the clamp body 28, thus securing the nose post 20 to the safety glasses.

As an alternative to a bolted-on nose post, the safety glasses may be molded with an integral nose post. Alternatively, a spring clamp, screw clamp, or similar removable structure may be used to attach the nose post to a pair of safety glasses that do not have a hole formed in their nose bridge.

Referring especially in FIG. 4, holding arm fastening pin 31 is held in cavity 30 by the legs of staple 38 extending through clamp body 28 and into annular groove 39 defined in fastening pin 31. The forward portion of holding arm fastening pin 31 defines threaded hole 40 to receive bolt 41 extending through hole 42 in the upper portion of holder arm 21 to fasten the holder arm to nose post 20.

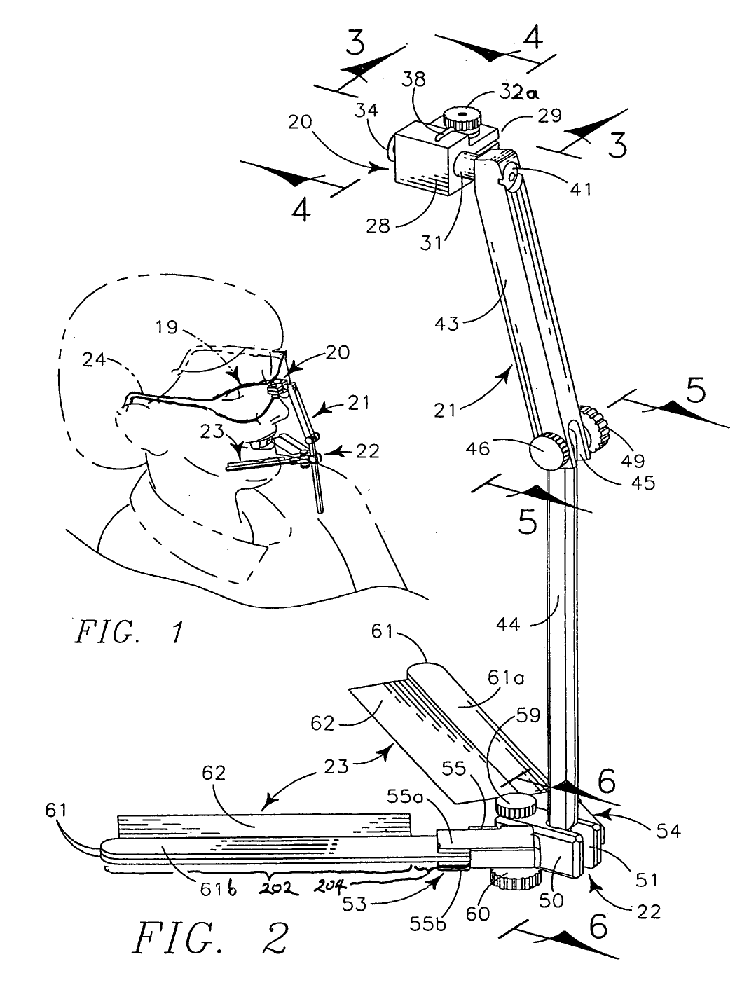

As seen particularly in FIGS. 2 and 5, holder arm 21 includes two fittings, each allowing rotation in one plane. As described above, the upper end allows rotation in a vertical lateral plane by the rotation of holder arm fastening pin 31 in cavity 30. A second fitting allows rotation of the lower portion 44 of holder arm 21 in a vertical anterior plane, relative to the upper holder arm portion 43. A bolt 46 and knurled nut 49 control the frictional resistance of the lower fitting in a manner similar to that of bolt 32 and knurled nut 32a of the upper fitting.

Spreader 22, as seen in FIGS. 1-2, 6-7, 12-13, and 18-20, includes body 50 defining vertical slot 51 extending through its forward portion and horizontal slot 52 extending through its rearward portion. The forward vertical slot 51 is configured as a fork fitting to receive the lower portion of holder arm 21 in a friction fit. As will be described later, the fork allows the spreader 22 to be quickly coupled to and uncoupled from holder arm 21 using fingertip pressure, while maintaining its position once established.

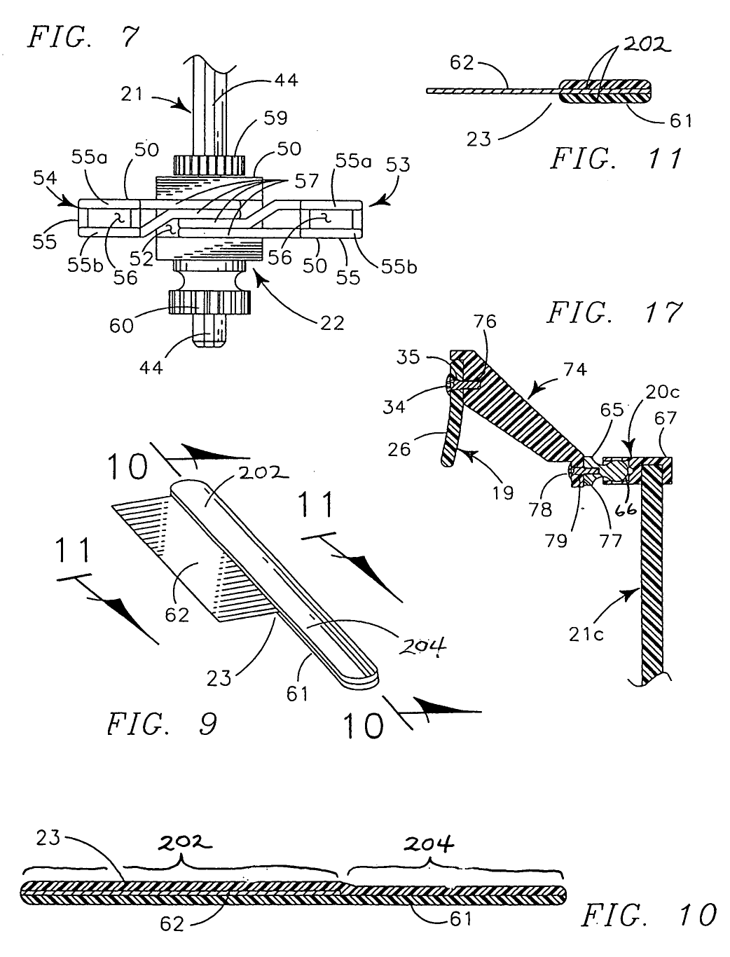

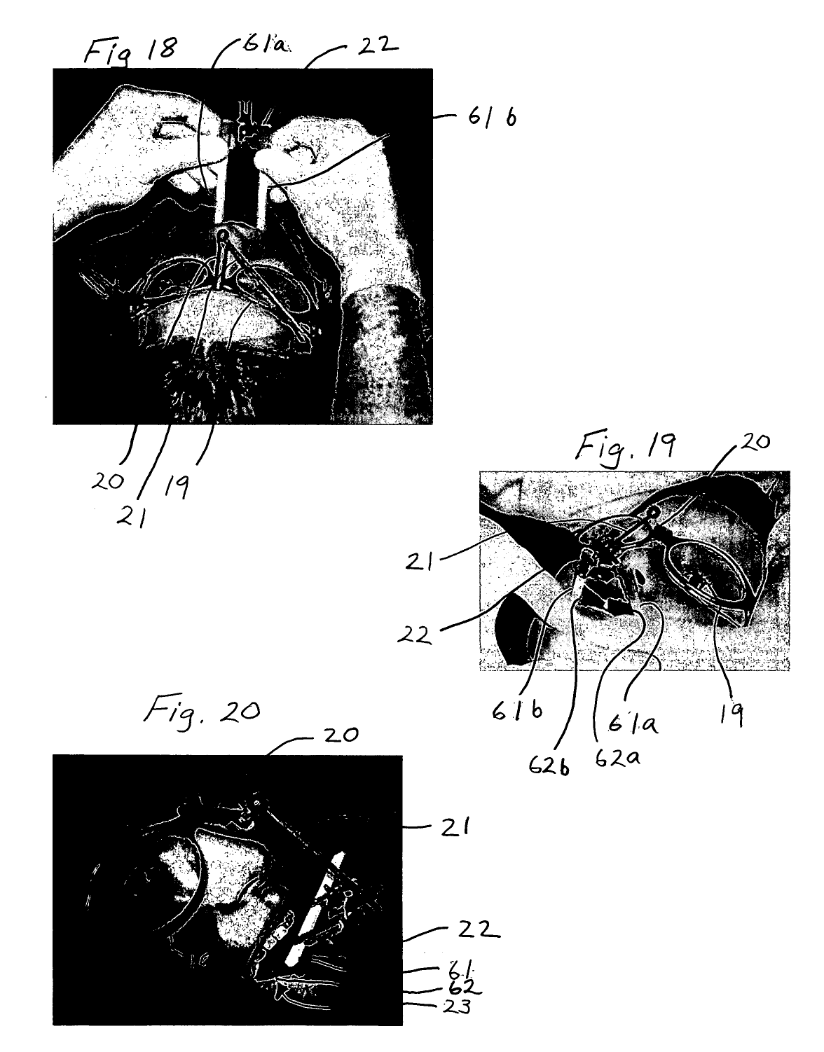

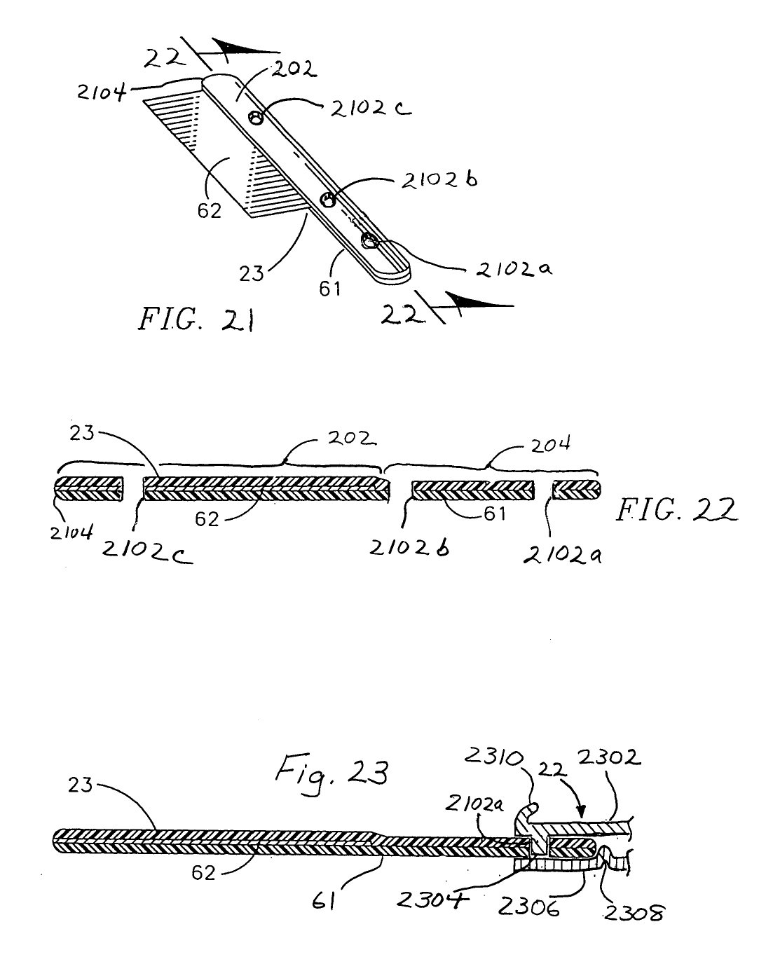

Rear horizontal slot 52, in the instance illustrated in FIGS. 6 and 7, carries two marking film mounting arms 53 and 54. Each mounting arm 53, 54 defines a holding element 55 (referred to elsewhere as holding element portions 55a and 55b), which in turn, defines a forceps receiving channel 56 therein. Forceps receiving channels 56 receive and hold the holding portion of a marking film and forceps assembly 23. The upper portions 55a and lower portions 55b of holding elements 55 extend from the rearward mouth of channel 56 to aid positioning of the holding portions marking film structures in channel 56. Additionally, the flanges formed by upper and lower portions of holding elements 55 allow a forceps to be inserted and held in a lateral position, as shown in FIG. 20.

Forward portions of each holding element 55 define perpendicularly extending fastening portions 57 that are carried in rear horizontal slot 52. The paired fastening portions 57 of each mounting arm 53, 54 are offset vertically relative to each other, as shown in FIG. 7, to maintain the channels 56 of both holding elements 55 in substantially the same horizontal plane to aid simultaneous tooth marking on both lateral aspects of the dental arches.

Each fastening portion 57 defines vertically oriented axially aligned holes 58 to bolt 59 therethrough for fastening by knurled nut 60. Bolt 59 extends through axially aligned holes 64 defined through body 50 in a position and axially coextensive with holes 58 in fastening portions 57 and engages knurled nut 60 on the opposite side the body By adjusting the tightness of knurled nut 60 on bolt 59, the friction against the fastening portions 57 of mounting arms 53 and 54 within slot 52 may be adjusted according to the preference of the designer and user. The frictional force resists pivotal motion of the two holding elements 55 relative to each other and to body 50. In some applications, it has been found that approximately 3 inch-ounces of frictional resistance works well for making movement of the spreader relatively easy while also maintaining a position once set.

In alternative embodiments, body 50 may be constructed with a single rearward-extending horizontal tab that includes a single hole 64 formed therethrough. In this configuration, fastening portions 57 of holding elements 55 may be offset to extend respectively above and below the single tab, while maintaining horizontal alignment of the forceps receiving channels. Bolt 59 may be replaced by a threaded shaft. Each end of the threaded shaft may be engaged by a respective wing nut to facilitate convenient and fast adjustment of the frictional resistance.

In some embodiments, it has been found advantageous to construct the body 50 integrally with the fork fitting of a relatively soft plastic material such as nylon or high density polypropylene, for example. The wing nuts are constructed of a similar material. The threaded shaft is formed from stainless steel, such as #304 stainless steel. Holding elements 55 are formed from an anodized aluminum. The resultant altering layers of plastic and hard materials in the width-adjustment mechanism of the spreader provide a forgiving and easily adjustable fit having a smooth transition from low to high frictional resistance. The relatively soft material of the fork fitting similarly provides a gentle and forgiving, yet secure coupling to the holder arm.

Marking film assembly 23, as seen especially in FIGS. 9-11 with marking film 62 engaged by the forceps 61, provide a relatively rigid body 61 having film holding portion 202 and handle fastening portion 204. The forceps 61 is formed from pieces of rigid or semi-rigid polymeric or paper material with a strip of dental marking film 62 sandwiched therebetween and extending laterally therefrom. The marking film assembly 23 generally, but not necessarily, is designed for single use applications, and if so, dental marking film 62 is joined to the adjacent portions of forceps 61 by a permanent joinder process such as gluing, fusing, crimping, or adhering, for example. In some applications, the portions of one or both sides of forceps 61 adjacent to the marking film are formed with protuberances that extending through the marking film and into indentations or holes in the opposite back portion. Alternatively, opposed sides of the back are joined by thermal welding processes or adhesion.

An alternative, reusable forceps is illustrated by FIGS. 27A, 27B, and 27C.

The handle portion 204 of forceps 61 is configured to fit within channel 56 of holding elements 55 in a frictional fit that is positionally sustaining but yet allows manual manipulation for insertion and removal. Fit between the forceps and holding elements 55 may be aided by forming one or more registration features on one or more surfaces of handle fastening portion 204 and/or the adjacent inner surfaces of holding elements 55 defining channel 56.

Some exemplary forceps registration features are illustrated by FIGS. 21-25.

Marking film 62 may be of the ordinary type commercially available. This marking film generally comprises a relatively thin flexible film of polymeric material or metallic foil, normally ranging in thickness from about 5 to 20 microns (0.0002 to 0.0008 in.) for proper marking. The marking film is of substantially rectilinear configuration with a length parallel to the longer dimension of forceps 61 of approximately 2.75 inches and a width perpendicular to the length of approximately 1 inch. Various sizes of forceps and marking film may be used to adapt to patients. One or both sides of the marking film are coated with transferable dye material that may be imprinted on tooth surfaces coming into contact therewith, especially when such contact has some slight impact or pressure. Commonly, if two-sided marking films are used, the colored marking dies on each surface are different in color from each other to avoid confusion in analyzing marks on patients' teeth.

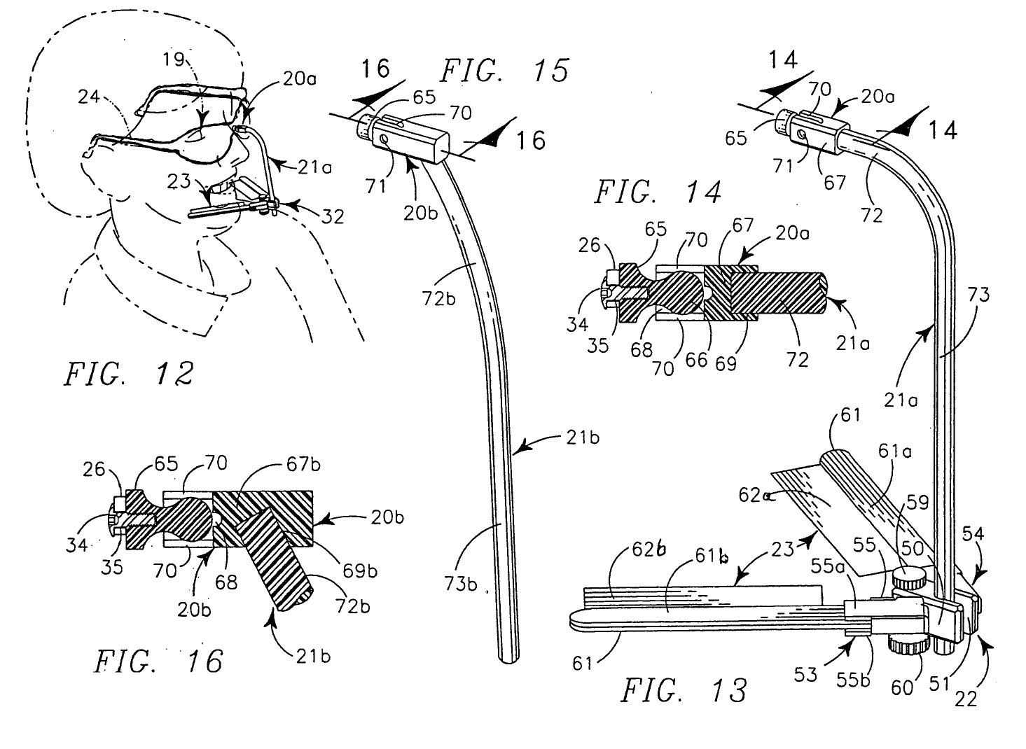

Another type of marking film holder having a unitary holding arm 21a and universal joint 20a is shown in FIGS. 12-17. In the embodiment shown in FIGS. 13 and 14, a short nose post 65 is attached to glasses nose bridge 26 with a fastening screw 34. The end of nose post 65 forms a ball 66. A mating socket 68 is formed by walls 70 extending from the fitting 67. The fitting 67 is coupled to the end of the holder arm 21a. When coupled, the ball-and-socket 66 and 68 forms a universal joint having a frictional fit that allows the holder arm 21a to be rotated at least in vertical lateral and vertical anterior planes and maintain its position. Thus, the single fitting 20a provides sufficient degrees of freedom to position the holder arm. As described earlier, fork fitting 51 may be conveniently attached and detached at various distances and at various angles to the holder arm 21a. Thus, the fork fitting provides additional degrees of freedom that allow the marking film holder to be quickly adapted to a range of patients.

Appropriate friction in the ball joint may be obtained by forming the interconnected elements from resiliently deformable materials that have a retentive memory such as plastics, for example nylon or high density polypropylene.

The holder arm 21a may be formed of a rigid material that need not change its shape for use, such as a plastic or metal material. In one application, it was found to be advantageous to form the ball 66 from anodized aluminum, the socket fitting 67 from a plastic material, and the holder arm 21a of an anodized aluminum. The holder arm is threaded into a hole formed in the socket body and may be engaged against the ball 66 with a force proportional to how far it is turned.

As depicted by FIG. 17, the nose post 65 was extended approximately an inch forward and downward from the glasses nose bridge. With the ball joint in this position, the holder arm was made straight and still cleared the tip of the patient's nose. Thus, the holder arm may be threaded into and out of the socket portion 67 of the universal joint without a bend in the holder arm causing misalignment of the bottom of the holder arm.

The film holder of FIGS. 15 and 16 uses a universal joint similar to that of FIGS. 13 and 14. In this case, the socket joint body 67b is somewhat longer and defines a downwardly and forwardly angulating hole 69b to receive the upper end of holder arm 21b.

As an alternative or in addition to a universal joint, the holder arm may be formed of a material that is plastically deformable with less retentive memory than described earlier. In this configuration, the holder arm 21b may be manually configured and thereafter will substantially retain a shape once established unless and until it is manually reconfigured. Various plastics having this physical characteristic are known and available.

Returning to FIG. 17, a forwardly in downwardly angulated nose post or mounting arm 74 extends from the nose bridge 26 of safety glasses 19 to a ball joint 66. FIG. 17 is a side-sectional view of this structure joined to socket fitting 20a, which is coupled to holder arm 21c.

The rearward portion of mounting arm 74 is fastened on the forward surface of nose bridge support 26 by bolt 34 extending through hole 35 defined in the nose bridge support and into engagement with the threads of hole 76 defined in mounting arm 74. The lower vertical surface 77 of the mounting arm 74 carries universal joint 20c, which is substantially the same as the universal joint 20a described above. Fastening portion 65 of universal joint 20c is structurally interconnected to the mounting arm 74 by bolt 78 extending through hole 79 defined in the mounting arm and into threaded engagement with fastening portion 65. The ball 66 carries socket body 67, which in turn carries vertically depending holder arm 21c. Holder arm 21c may be substantially the same as the fastening rods 21a or 21b and may be a vertically depending linear fastening rod of either rigid or manually moldable nature. The forwardly and downwardly angulated mounting arm 74 allows the holder arm 21c to clear the nose of the patient.

FIGS. 18, 19, and 20 are perspective views that illustrate use of the occlusal marking system. Safety glasses 19, worn by the patient, support nose post 20, to which holder arm 21 is connected via a universal joint. FIG. 18 illustrates a preferred technique for inserting the marking film. The practitioner holds the spreader 22 with the forceps 61a and 61b straight, and inserts the forceps and marking film assemblies into the patient's mouth. After insertion, the spreader is opened using the thumbs and forefingers of both hands to a width appropriate for the width of the patient's dental arches.

After insertion of the marking films into the patient's mouth, the practitioner may rotate connecting rod 21 to an appropriate position and clip spreader 22 thereto. The connecting rod 21 is coupled to the spreader fork by holding the spreader with one hand and pushing the rod into the fork with the index finger. Correct placement of the marking films may be quickly visualized. The patient is now ready for bi-manual manipulation or other mandibular movement.

Connecting rod 21 may be adjusted for frictional characteristics against the nose post 20 by a setscrew, spring, elastic properties, surface treatment, or other known methods.

FIG. 19 illustrates this position, wherein spreader 22 gently holds forceps 61a and 61b laterally against the patient's cheeks, a position that maintains proper alignment of marking films 62a and 62b with the patient's teeth. Anterior-posterior as well as medial-lateral alignment of the film holder 22, and hence the marking films 62a and 62b, is maintained by the position of connecting rod 21.

To remove the occlusal marking system, the thumb is place on the fork of the spreader and pinched to lift the rod with the forefinger. The freed connecting rod is rotated to one side. The spreader is closed and removed. The operator can see interferences marked on the films or on the teeth. In contrast to prior art, which may for example use hand-held Miller forceps, it is easy to keep the marking ribbons straight and dry. As an alternative, the forceps described herein may also be hand-held as may be desired.

FIG. 20 illustrates an alternative position for holding a marking film structure 23 in a patient's mouth. The position illustrated in FIG. 20 is especially appropriate for testing the bite of a patient's front teeth and may be used to harmonize the anterior guidance. Spreader 22 is clamped onto two locations on forceps 61, thus holding it in a laterally extensive position to hold marking film 62 in the proper position between the patient's front teeth.

Marking film assembly 23 may be comprised of a marking film 62 adhered permanently to forceps 61. As an alternative to use of film holder 22, marking film assembly 23 may be manually inserted and held in the patient's mouth by a practitioner or assistant directly gripping extended end 204 of forceps 61. Thus, marking film assembly 23 may comprise a disposable unit that eliminates the need for cleaning forceps or tediously inserting marking film 62 into forceps. Such a product may be individually or multiply packaged according to user or seller preference.

FIGS. 21 and 22 illustrate a first alternative forceps design that includes features for maintaining coupling stability with the film holder. Registration feature 2102a, here illustrated as a hole, provides a feature into which a corresponding pin in film holder 22 may be inserted. The use of such a registration feature not only aids in the rigidity of the structure, it also ensures that marking film structure 23 is withdrawn from the patient's mouth when film holder 22 is pulled anteriorly out of the patient's mouth. Optional registration features 2102b and 2102c, here illustrated as holes, provide similar positive interlocking of the film holder 22 and marking film structure 23 in the laterally extensive position of FIG. 20.

Additionally FIGS. 21 and 22 illustrate the blunt tip 2104 of forceps 61. As previously described, this blunt tip can aid in placement and registration of marking film structure 23 against the vertical extension of the patient's jaw bone. Making tip 204 blunt, rounded, and smooth may help to maximize patient comfort. In another aspect, patient comfort may be maximized by forming forceps 61 from a material that is relatively smooth and non-abrasive. Additionally or alternatively, the material may be chosen based on a low thermal conductivity and/or relative softness. These properties can improve the sensation of sliding against the cheek as well as reduce the rudeness of unintended collision with the patient's teeth.

Extended end 204 of forceps 61 may alternatively comprise features such as dimples, a tab, or other to improve the ergonomics of manually holding the marking film assembly 23 and/or inserting marking film assembly 23 into the forceps channels 56 of spreader 22.

FIG. 23 illustrates a method for mating the forceps of FIGS. 21 and 22 with a film holder 22. Here, extending portion 204 (see FIG. 22) of forceps 61 is inserted into film holder 22, all parts shown in cross-section. Moveable clamp 2302 includes pin 2304 sized to fit into registration hole 2102a. Ideally, pin 2304 is sized to easily slide into registration hole 2102a without interference sufficient to cause the pin to “hang-up” during extraction. Moveable clamp 2302 may be formed, for instance, from an elastic material that allows the far end of moveable clamp 2302 (not shown) to be held in a fixed position, the swinging of moveable clamp 2302 being accomplished by elastic deformation of the part itself. Anvil 2306 forms a bottom support for forceps 61 with stop 2308 defining the allowable insertion depth of forceps 61. Moveable clamp 2302 may optionally include tab 2310 to aid the ease of gripping moveable clamp 2302 during insertion and extraction of forceps 61 from film holder 22.

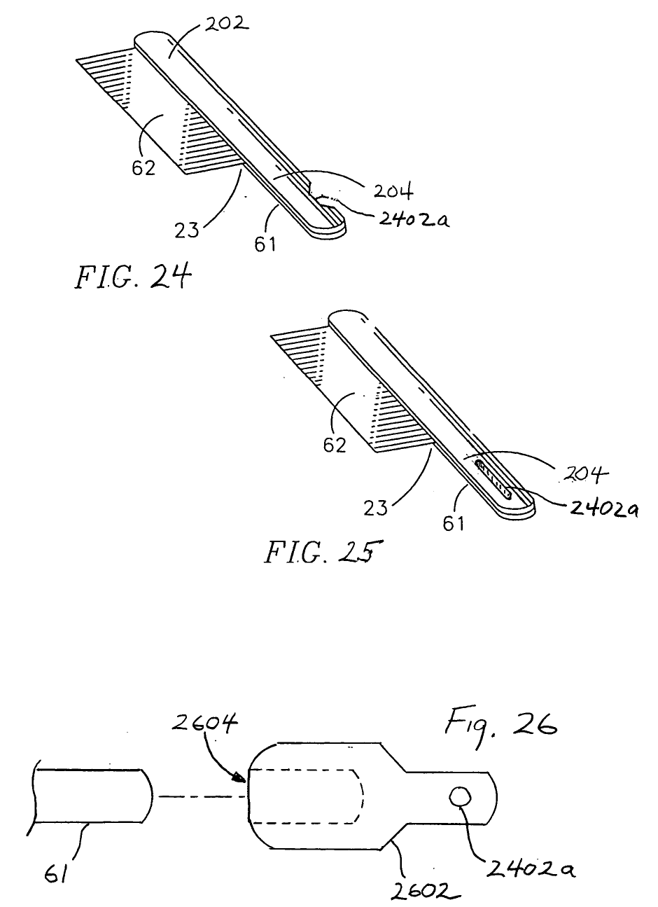

FIG. 24 illustrates a marking film 23 having an alternative registration feature 2102a formed in the extended end 204 of forceps 61. In this case, registration feature 2402a is formed as a notch in extended end 204 of forceps 61. Optionally, location features 2402b and/or 2402c may additionally be formed as notches at appropriate positions along forceps 61.

FIG. 25 illustrates a marking film 23 having another alternative registration feature 2102a. In this case, registration feature 2402a is formed as a groove in extended end 204 of forceps 61. In this case, a corresponding ridge would be formed in the forceps channels 56 of film holder 22 (not shown). In other embodiments the size and shape of the holding portion 204 itself of forceps 23 may serve as a registration feature. Thus a friction, spring, or interference fit of a smooth holding portion against the forceps accepting features of spreader 22 may serve to register and securely hold the forceps. In one embodiment, this is achieved by specifying the holding portion 204 of forceps 23 to be 0.25 inch wide by about 0.07 inch thick.

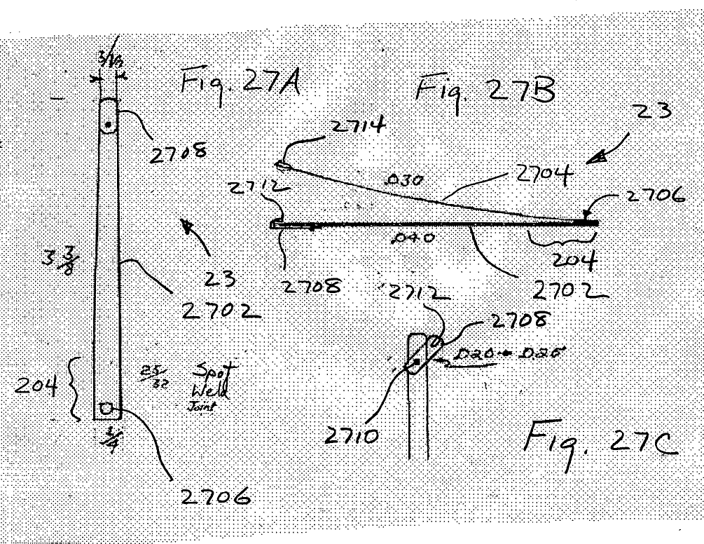

FIG. 26 illustrates an adaptor 2602 for adapting forceps to a film holder having registration features. In this case, forceps 61 need not have registration features, or alternatively may have different registration features than film holder 22. This arrangement could allow, for instance, one manufacturer's forceps to be used with another manufacturer's film holder. In this case, adapter 2602 includes a slot 2604 formed to accept alternative forceps 61. Adaptor 2602 is shown having a registration feature 2402a comprising a hole similar to the embodiment of FIGS. 21 and 22. Adaptor 2602 may, for instance, be formed of a soft elastic material such as silicone rubber or polyurethane to facilitate insertion and gripping of alternative forceps 61.

FIGS. 27A and 27B are respective top and side views of an alternative dental marking film forceps 23. A relatively rigid and elongate back portion 2702 forms a frame for holding the marking film (not shown). Back portion 2702 may, for example, be formed from 0.040 inch thick flat stock #304 stainless steel. The proximal end of back 2702, which in this example is formed 0.25 inch wide, forms a holding portion 204 that is adapted to be accepted by the acceptor cavity 56 shown in FIG. 7, formed from structure 55 shown especially in FIGS. 2, 7, and 13. A clamp portion 2704, seen especially in FIG. 27b, is formed from 0.030 inch thick spring stock #304 stainless steel and is permanently affixed to back portion 2702 at the proximal end by spot weld 2706.

In one embodiment, alternative forceps 23 tapers from approximately 0.25 inch wide at its proximal end to approximately 0.1875 inch wide at its distal end and includes a rounded distal end to avoid gouging the patient. The length of the example shown in FIGS. 27A-C is approximately 3.375 inches, although this may be varied according to the preferences of the practitioner and the depth of a patient's dental arches. A variety of sizes may be kept on-hand to adapt to patients.

As may be appreciated from inspection of FIGS. 27A and 27B, clamp 2704 is separable from back 2702 to allow a piece of dental marking film to be placed therebetween. The distal end of alternative forceps 23 includes a latch 2708 for pinching the back and clamp portions together to hold dental marking film. FIG. 27C illustrates the latch mechanism in the open position.

Latch 2708 is rotatably coupled to back 2702 by a rivet 2710. A detent 2712 formed on the lip of latch 2708 for engagement of a corresponding detent 2714 formed on clamp 2704. Engagement of detent features 2712 and 2714 holds clamp 2708 shut, thereby ensuring that clamp 2704 is held tightly enough against back 2702 to secure a piece of dental marking film therebetween.

In the clinical setting, alternative articulating film forceps 23 may be cleaned and/or sterilized between patients. A technician or dentist places a piece of dental marking film between back 2702 and clamp 2704 and secures the clamp and back together by rotating latch 2708 to engage detents 2712 and 2714. After use, the technician or practitioner rotates latch 2708 into an open position corresponding to FIG. 27C, springably releasing clamp 2704 from back 2702, and releasing the articulating film therefrom. The procedure may then be repeated for the next patient or the forceps may be immediately used in a different position on the same patient.

Although the alternative forceps 23 shown in FIGS. 27A, 27B, and 27B is shown with a particular choice of materials, joining and latching mechanisms, and dimensions, alternatives may be employed as would be apparent to one skilled in the art. For example, the material may be formed from a plastic, alternative metal, paper, wood, or other material depending upon economic, performance, and safety considerations. The clamp and back portions may be joined via a variety of known fastening methods, including but not limited to integral forming, molding, gluing, screwing, crimping, and other methods. The latch mechanism may be altered or placed on the proximal end. The holding portion 204 may be altered according to the shape of the forceps accepting channels and/or may be extended to facilitate hand-held use.

If constructed of the materials shown, a micro break press may be used to form certain features. The edges of the material are optimally radiused to ensure patient and practitioner comfort and safety.

The preceding overview of the invention, brief description of the drawings, and detailed description describe exemplary embodiments of the present invention in a manner intended to foster ease of understanding by the reader. Other structures, methods, and equivalents may be within the scope of the invention. As such, the scope of the invention described herein shall be limited only by the claims.

What is claimed is:

1. An apparatus for measuring a patient's bite, comprising:
a mount for removable attachment to a mounting point positioned relative to a patient;
a mechanical coupling coupled to the mount; and
an articulating film holder coupled to the mechanical coupling.

2. The apparatus for measuring a patient's bite of claim 1, wherein the mount for removable attachment is adapted to clamp to a pair of glasses worn by the patient.

3. The apparatus for measuring a patient's bite of claim 1, wherein the mount for removable attachment is adapted to couple to a mechanical mounting point on a pair of glasses worn by the patient.

4. The apparatus for measuring a patient's bite of claim 3, wherein the mounting point and the mount for removable attachment form a ball-and-socket joint when coupled.

5. The apparatus for measuring a patient's bite of claim 3, wherein the mount is adapted to couple to a mounting point supported by apparatus indirectly positioned relative to the patient.

6. The apparatus for measuring a patient's bite of claim 5, wherein the mount is adapted to couple to a mounting point supported by the patient's chair.

7. The apparatus for measuring a patient's bite of claim 1, wherein the mechanical coupling allows for adjustment of the position of the articulating film holder.

8. The apparatus for measuring a patient's bite of claim 7, wherein the mechanical coupling allows for adjustment of the position of the articulating film holder, each position being substantially held stably until readjustment.

9. The apparatus for measuring a patient's bite of claim 7, wherein the mechanical coupling comprises one or more moveable joints.

10. The apparatus for measuring a patient's bite of claim 7, wherein the mechanical coupling comprises one or more flexible members.

11. The apparatus for measuring a patient's bite of claim 1, wherein the articulating film holder allows for adjustment of the articulating film position.

12. The apparatus for measuring a patient's bite of claim 11, wherein the articulating film holder allows for lateral adjustment of the articulating film position to match the width of the patient's dental arches.

13. The apparatus for measuring a patient's bite of claim 12, wherein the articulating film holder is adapted to be guided to a position in the patient's mouth by gliding along the patient's cheeks.

14. The apparatus for measuring a patient's bite of claim 1, wherein the articulating film holder is adapted to receive one or more forceps that hold articulating film.

15. The apparatus for measuring a patient's bite of claim 1, further comprising a pair of safety glasses that include a mounting point.

16. An article of manufacture for measuring a patient's bite, comprising:
an articulating film having at least one marking surface, and
a disposable forceps affixed along one edge of the articulating film, and
a package containing the articulating film and disposable forceps assembly for delivery to a user.

17. The article of manufacture of claim 16, wherein the disposable forceps are affixed to the articulating film by mechanical clamping.

18. The article of manufacture of claim 16, wherein the disposable forceps are affixed to the articulating film by adhesion.

19. The article of manufacture of claim 16, wherein the disposable forceps extend longitudinally from the articulating film to form a holding tab that extends a distance corresponding to being at least partially outside the patient's mouth when in use.

20. The article of manufacture of claim 19, wherein the holding tab is formed to be received by an articulating film holder.

21. The article of manufacture of claim 20, wherein the holding tab is about 1/4 inch wide by about 1/16 inch thick.

22. A holder for coupling articulating film to an articulating film holder, comprising:
an articulating film receiver, and
a holding tab mechanically coupled to the articulating film receiver, the holding tab being formed to be received by an articulating film holder.

23. The holder for coupling articulating film to an articulating film holder of claim 22, wherein the holding tab is about 1/4 inch wide by about 1/16 inch thick.

24. The holder for coupling articulating film to an articulating film holder of claim 22, wherein the articulating film receiver includes a slot for receiving a holding tab of an articulating film forceps.

25. The holder for coupling articulating film to an articulating film holder of claim 22, wherein the articulating film receiver further includes:
a flexible film having first and second surfaces,
a pressure sensitive adhesive formed on a first surface of the flexible film, and
at least one elongate member affixed to the second surface of the flexible film, the at least one elongate member being adapted to fold longitudinally to clamp articulating film between opposing first surfaces of the flexible film.

26. The holder for coupling articulating film to an articulating film holder of claim 25, wherein the at least one elongate member includes two elongate members substantially abutting one another.

27. The holder for coupling articulating film to an articulating film holder of claim 25, wherein the at least one elongate member includes a score to ease longitudinal folding.

28. An occlusal marking system, comprising;
a nose post,
a holder rod operable to couple to the nose post, and
a spreader operable to reversibly couple to the connector rod by a moveable joint, the spreader being adapted to accept occlusal marking film forceps.

29. The occlusal marking system of claim 28, wherein the holder rod is operable to couple to the nose post through a universal joint.

30. The occlusal marking system of claim 29, wherein the universal joint is a ball-and-socket joint.

31. The occlusal marking system of claim 28, wherein the spreader is operable to reversibly couple to the holder rod by a fork joint.

32. The occlusal marking system of claim 28, wherein the spreader is operable to reversibly couple to the holder rod through a joint that may be coupled and uncoupled without the use of tools.

33. The occlusal marking system of claim 28, wherein the spreader further includes a rotatable coupling for adjusting the width of occlusal marking film forceps.

34. The occlusal marking system of claim 33, wherein the spreader rotatable coupling includes a friction fitting for holding a set width of occlusal marking film forceps.

35. The occlusal marking system of claim 33, wherein the spreader rotatable coupling includes a spring to urge held occlusal marking film forceps laterally.

36. The occlusal marking system of claim 28, further comprising a pair of glasses whose nose bridge includes an affixed to the nose post.

37. The occlusal marking system of claim 28, wherein the nose post includes a clamp to reversibly couple to the bridge of a pair of glasses.

38. The occlusal marking system of claim 28, wherein the spreader is adapted to hold a pair of occlusal marking film forceps longitudinally.

39. The occlusal marking system of claim 28, wherein the spreader is adapted to hold a single occlusal marking film forceps laterally.

40. The occlusal marking system of claim 28, further comprising at least one occlusal marking film forceps.
